(19) United States
(12) Patent Application Publication
(10) Pub. No.: US 2021/0304266 A1
(43) Pub. Date: Sep. 30, 2021

(54) INVOICE PAYMENT SYSTEM

(71) Applicant: Zycus Infotech Pvt. Ltd., Mumbai (IN)

(72) Inventors: Durga Prasad, Mumbai (IN); Neha Kale, Mumbai (IN); Vijesh Bhakta, Mumbai (IN); Bikash Mohanty, Mumbai (IN)

(73) Assignee: Zycus Infotech Pvt. Ltd., Mumbai (IN)

(21) Appl. No.: 17/206,515

(22) Filed: Mar. 19, 2021

(30) Foreign Application Priority Data
Mar. 26, 2020 (IN) 202021013127

(51) Int. Cl. G06Q 30/04; G06Q 20/10; G06Q 20/40; G06Q 10/10

(52) U.S. Cl. CPC G06Q 30/04; G06Q 10/107; G06Q 20/405; G06Q 20/102

(57) ABSTRACT

An invoice payment system involving smart electronic means which is enabled to read, reply, segregate, de-duplicate and appropriately mark undisputed emails with genuine payable invoice for payment; wherein the “payment query” emails are resolved by generating automated replies based on email content; and wherein the emails for payment marked “add invoice” include the steps of: (i) identification and classification of received emails; (ii) eradicating duplicate invoices; (iii) checking dispute if any with associated invoice or supplier; and (iv) if all checks are appropriate, then flagging the email with a green mark for further processing of the invoice by the smart electronic means.

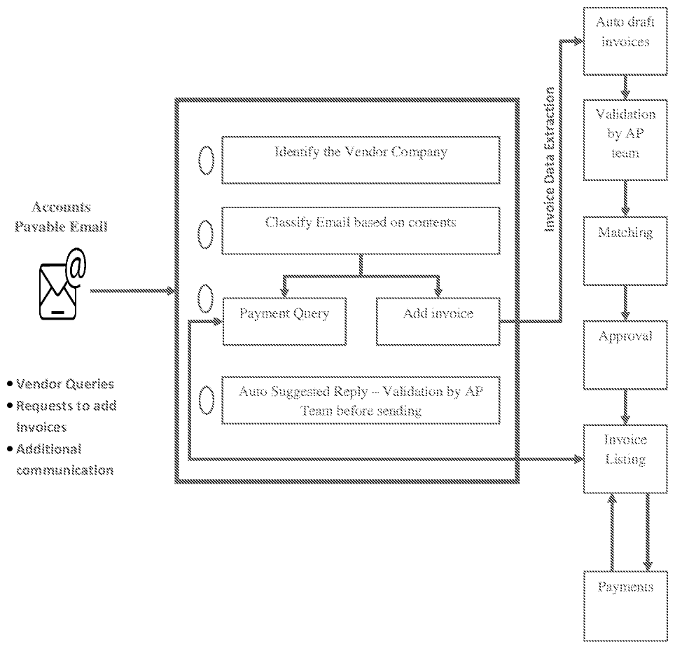

### CROSS-REFERENCE TO RELATED APPLICATION

The instant application claims priority to Indian Patent Application Serial No. 202021013127, filed Mar. 26, 2020, pending, the entire specification of which is expressly incorporated herein by reference.

### FIELD OF THE INVENTION

The present invention relates to invoice payment system that segregates and processes payable invoices based on input emails/invoices by vendors using smart electronic means.

### BACKGROUND OF THE INVENTION

Traditionally, business transactions were carried out via exchange of paper invoices being used as a memo to receive payments. Managing paper invoices and processing them appropriately within a given time frame was a daunting task to the service user. Loss of invoices, mismanagement and hence slow down in business was often a result of this cumbersome payment method. E-invoice soon took over for ease of process of business payments. However, none of the methods available till date are such that they are fully efficient, errorless, and accurate such that no human or artificial intelligence (AI) will have to spend repeated time and energy over the same request to process the invoices for payments.

While organizations spend a large amount of time on punching the invoice data, a considerable amount of time is spent on managing and responding to emails from suppliers and internal requestors. Email content could range from attaching an invoice for processing, seeking invoice status, asking remittance information or even sending same invoice multiple times.

On an average, a USD2Bn organization receives anywhere from 120-150 emails a day. The AP team cannot afford to ignore even a single email. Looking into the inbox, sifting through emails, understand the supplier email, gathering relevant data and responding to supplier emails consumes a lot of time. It is estimated that the supplier response could take anywhere from 2 minutes to 3 days when suppliers fail to mention the PO number on a valid PO backed transaction.

U.S. Pat. No. 6,292,789 discloses a method and system for presentment of bills on a computer network including a biller account hosted on a server of a bill service provider for receiving a bill file from a biller that includes bill data. The biller account automatically formats a bill for a consumer from the bill data. This process is however not error proof. Does not talk of duplicate invoices, or means of assessing undisputed invoices.

U.S. Pat. No. 6,882,98 describes a method for automatic processing of invoices wherein a computerized method of automatically generating payment for electronic billing data including automatically obtaining billing data in an electronic format from a billing party for a billable party, and automatically comparing the billing data with rule data defined by the billable party. The method includes automatically authorizing generation of payment data for the billing party if the billing data satisfies the comparison with the rule data is described. However, this particular document fails to exactly elaborate how the system works or how duplicates are eradicated. Further, the described invention completely fails to eliminate payment of disputed invoices, if any.

Thus, it is seen that even though auto processing of invoices is attempted in certain prior arts it is not full proof or a cent percent method to resolve the input query or payment request to its finality. Some prior arts talk of auto responding to query mails based on general input keywords however do not further process the request wherein again a human resource is necessary to complete the transaction.

Thus, there is need for a fully automated system and method for segregating and processing invoices till finality without human intervention/physical efforts/input of time and energy of resources for quick and efficient timely payment of invoices.

### Definitions

The abbreviation “AP” used hereinafter in this specification is an abbreviated form of “Accounts Payable” with the same meaning and understanding to any person as used in any e-commerce or other commerce platforms.

The abbreviation “PO” used hereinafter in this specification is an abbreviated form of “Payment Order” with the same meaning and understanding to any person as used in any e-commerce or other commerce platforms.

### OBJECTS OF THE INVENTION

The primary object of the present invention is to provide a novel system for payment of invoices.

Yet another object of the present invention is to provide a method for segregating and processing payable invoices.

Yet another object of the present invention is to reduce the settlement time between raising and closing of an invoice request/query.

Yet another object of the present invention is to generate automated reply to invoice request/query mail based on input email data.

Yet another object of the present invention is to process input mail to generate appropriate reply and/or trigger cascade of events leading to settling of the payment invoice.

Yet another object of the present invention is to flag and separate duplicate and disputed invoices.

Yet another object of the present invention is to identify undisputed invoices for further processing.

Further the object of the present invention is to save physical efforts, time and increase productivity on the whole.

### SUMMARY OF THE INVENTION

The present invention discloses a system which involves smart electronic means for payment of invoices in a quick and efficient manner. The smart electronic means of the system is such that the vendor emails are read, deconstructed into keywords, and an automated accurate response is sent to the supplier. In case the email is for payment information, the intelligent system will initiate a flow of steps to identify and process undisputed payable invoices automatically in a quick and efficient manner.

The invoice payment system of the present invention involves smart electronic means that initiate and carry out array of steps to achieve payment of input invoices. The system, apart from generating automated email reply, is a smart desk application that reads all emails present in the inbox and intelligently identifies emails containing invoice details or attachments for action. The electronic means read the contents for any further action. If there is any invoice attached to the email then this invoice is processed within the application to read the invoice attachment and the following actions are performed: Identifying if this email containing invoice was earlier replied, if this email containing invoice is a duplicate invoice, if this email containing invoice passes the check for undisputed invoice for this the application matches with PO, requisite contract terms, check in the inbox if this invoice was earlier objected for payment, running the invoice check list which includes check list containing all necessary fields which needs to be there in the invoice-like goods/service line item description, qty, price for each qty, tax rates, etc.

The electronic means also check the preloaded invoice blocker checklist to ensure it is undisputed invoice and provide green ticks and red ticks, if any, to the blocker checklist upon completion of all checks and the undisputed invoices with green ticks are processed for payment.

### BRIEF DESCRIPTION OF THE DRAWINGS

The FIGURE shows a detailed flow chart of pre-determined steps performed by the smart electronic means of the invoice payment system.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise,” or variations such as “comprises” or “comprising,” will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

Invoice payment is a daunting task for the service provider, since not even a single invoice can be missed, miscalculated or wrongly processed. The invoices received on daily basis are so high in number that the electronic means need to function very accurately and precisely for an errorless and accurate invoice processing.

The invoice payment system of the present invention is a manifoldly advanced payment system that involves smart electronic means which eradicates all errors, duplicates, fraud invoices and processes only the genuine ones in a quick and efficient manner.

The system is a proprietary smart desk application that reads the vendor emails, deconstructs the email into keywords and creates an automated response to the emails.

Referring to the FIG. of the present invention, whenever there is a new accounts payable email in the e-invoice application of the present system regarding vendor queries, or request to add new invoice for payment, or any other additional communication the smart electronic means of the system performs a sequence of pre-determined steps as shown in the flow chart of the FIG. The smart electronic means firstly identifies the sender vendor company, then it classifies the email into either one of the two main criterion of i) “payment query,” or ii) “add invoice.” If an email refers to a payment query and not a new invoice for payment then the invoice listing is checked. If payment of the invoice is still due then invoice raised further for payment. If payment already done an appropriate reply is generated which can be viewed and sent by the AP manager. If the email contains invoice which is new then it is added for further processing through the “add invoice” route. The smart electronic means of the system extracts data from such new invoices, the auto drafted invoice is validated by the AP team, and on validation if the invoice is no duplicate or disputed it is further listed for payment.

In one embodiment of the present invention in case the email is for payment query, the system will generate an appropriate reply with suggested content with the help of the smart electronic means. This automated response will contain the details of remittance advice and can be reviewed and forwarded to the sender of the email.

Whenever a new invoice with no previous history/match is detected by the system of the present invention it, firstly sends appropriate reply to the sender and further executes array of steps that include validating genuine invoices to be reviewed for processing by the AP team Manager.

In yet another embodiment of the present invention in case a payable invoice is detected by the system it gives rise to an array of scheduled/pre-determined steps to process the payable invoice and mark the email content for payment wherein all duplications are eradicated by the intelligent system.

An array of pre-determined steps as triggered on encountering a payable invoice include:

the intelligent system reads emails in the inbox of user;

identification and segregation of emails containing invoice or emails containing any other details regarding payment query is then done;

scanning done through past emails and invoice procurement system for same invoice number to identify if payment has been done in the past or whether the present invoice is a revised invoice or whether it is an unpaid invoice; and

further scanning done to mark an undisputed invoice by reading the contents of the invoice and by extracting the metadata fields of the invoice.

The system then scans through the preloaded invoice blocker checklist to ensure the invoice is undisputed and payable.

On encountering such a non-disputed, non-duplicate invoice, these final payable invoices are marked with green ticks and the disputed ones with red ticks upon completion of all checks.

For ensuring selection of undisputed invoice for payment the smart electronic means search the inbox to assess if there are any objections or disputes or issues related to the invoice. If the electronic means finds any issues in the past emails connected to the invoice or issues with the supplier as interacted on emails, it blocks payment of invoice and raises red flag in the check list and sends alert to the compliance team for action. Only after and if the compliance team approves and removes the red flag attached with the invoice, the smart electronic means take the invoice for further action and other checks.

The system is programmed to read and extract data not only from the content of the email but also the attachment files in word, PDF or other formats. The system also extracts invoice metadata from PDF's that are either manually uploaded in bulk or automatically downloaded from AP inbox. The intelligent system extracts metadata from these attachment files, header level details as well as line level details to have accurate invoice data for further processing to find duplicate invoices.

In yet another embodiment of the present invention the process of identifying and removing duplicate invoices includes steps as follows:

All the invoices stored in the e-invoice application and AP manager inbox are scanned firstly for the same combination of the invoice number and supplier name. If combination is already present the invoice is flagged as “duplicate.”

If it is a payment order then combination of same payment order with same date and same invoice total with same line entry is checked. If combination is already present it is flagged as possible “duplicate.”

In yet another embodiment of the present invention if there is any invoice attachment within the e-invoice application it is processed by reading the invoice attachment and performing the following actions; (i) check to see if the email containing invoice was earlier replied; (ii) check to see if the email containing invoice is a duplicate invoice; (iii) check to see if the email containing invoice passes the check for undisputed invoice; (iv) check to see if the invoice is undisputed and if it matches the email content with payment orders, requisite PO contract terms, and good receipt terms in the inbox; and (v) check to see if this invoice was earlier objected for payment, and to run the invoice check list for the same.

The check list contains all necessary fields which need to be there in the invoice-like goods/service line item description, qty, price for each qty, tax rates, etc.

This check carried out by the system in the Invoice blocker checklist includes line level checks of items like:

check repository of invoices for duplicates;

check PO metadata fields;

check good receipt metadata fields;

check AP user inbox for any past issues with the supplier named on invoice or past issues with the invoice contents mentioned in the invoice;

check contract payment terms; and

check tax rates, etc.

If no issues are found, then the system correlates the metadata fields of invoice with tagged contract for the invoice and maps the payment terms mentioned in the invoice.

Thus, the system of the present invention is not just automated email reply system but, the smart electronic means of the system reads all emails present in the inbox, intelligently identifies emails containing invoice details or attachments and readies it for further action accurately and in less time.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA,” a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices) multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An invoice payment system, comprising:
a smart electronic means that is enabled to read, reply, segregate, de-duplicate and appropriately mark undisputed invoices with genuine payable requests for payment.

2. The system as claimed in claim 1, wherein the electronic means segregate emails based on two main criteria of payment query and adding payment invoice.

3. The system as claimed in claim 1, wherein the electronic means generate automated responses to input emails for payment query and, wherein in the case of payment requests, the details of invoice will be processed to initiate a remittance in a stepwise manner.

4. The system as claimed in claim 1, wherein the electronic means is enabled to read email content at a header and line level and all attachments in any format for payable invoice information.

5. The system as claimed in claim 1, wherein the electronic means is enabled to recognise and eradicate undisputed invoices.

6. The system as claimed in claim 1, wherein the steps for generating an automated reply by the electronic means to a payment query email include:
a) receiving a vendor query input email;
b) identification of a vendor company;
c) classification of emails in the two main criteria; and
d) sending an automated response to the email if it belongs to a payment query category.

7. The system as claimed in claim 1, wherein the steps carried out by the electronic means for add an invoice route for a payable invoice include:
a) receiving a vendor query input email;
b) identification of a vendor company;
c) classification of emails in the two main criteria;
d) identifying payable invoices and adding them to an e-invoice application for payment; and
e) marking undisputed and genuine invoices with green marks and disputed invoices with a history with red marks before adding them to an e-invoice application.

8. The system as claimed in claim 1, wherein a process to recognize and eradicate duplicate invoices by the electronic means includes the steps of:
(i) scanning an e-invoice application and AP manager inbox for the same combination of an invoice number and supplier name to be checked;
(ii) if the same combination is already present, then flagging the invoice as a duplicate or else marking a green tick thereon for further processing;
(iii) scanning payment orders for a payment order with the same date, same invoice total and with same line entry; and
(iv) if the combination is already present, then flagging the invoice as a duplicate or else marking same with a green tick for further processing.

9. The system as claimed in claim 1, wherein a process to flag disputed invoices by the electronic means includes the steps of:
(i) scanning all past emails related to an invoice or a supplier based on interactions in an email content;
(ii) if any issues are found in the scan, then blocking payment of the invoice and flagging with a red mark to the email and simultaneously sending an alert to a compliance team;
(iii) if the compliance team approves and removes the red mark, then marking the email with a green mark for further action;
(iv) mapping invoice metadata with contract metadata containing a payment schedule to mark discrepancies, if any: and
(v) mapping an invoice tax rate with a tax rate database for a transaction and marking discrepancies, if any.
